(19) United States
(12) Patent Application Publication
(10) Pub. No.: US 2005/0122704 A1
(43) Pub. Date: Jun. 9, 2005

(54) Method for supporting reflector in optical scanner, optical scanner and image formation apparatus

(75) Inventors: Masanori Yoshikawa, Osaka (JP); Hideo Hirose, Osaka (JP); Masaaki Nakano, Osaka (JP); Ikuko Katou, Kyoto (JP); Keisuke Fujimoto, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD

(21) Appl. No.: 10/973,340

(22) Filed: Oct. 27, 2004

(30) Foreign Application Priority Data
Oct. 29, 2003 (JP) 2003-369479
Nov. 13, 2003 (JP) 2003-383437

(51) Int. Cl. G03B 15/02

(52) U.S. Cl. 362/8

(57) ABSTRACT

A reflector 10 is formed so as to have a long side along a scanning direction of a ray bundle. The reflector 10 includes a thin-plate-shaped reflector body having one plane to be a reflection plane 20 and upper and lower ribs 21a and 21b each extending from the reflector body in a back side. The reflector plane 20 is formed of a curved plane having positive power at least in the scanning direction, i.e., a so called free-form plane. The reflector 10 is supported by protrusions 31, 32 and 33 at three points, i.e., first, second and third support points S1, S2 and S3 located in the vicinities of one end portion of the reflector, the other end of thereof, and a center portion thereof, respectively. A distance L1 between an imaginary straight line V1 joining the first and second support points S1 and S2 and the third support point S3 is larger than a sag L2 of the reflector 20. The center of gravity G of the reflector is located inside of an imaginary triangle V3 joining the first, second and third support points S1, S2 and S3.

### CROSS-REFERENCE TO RELATED APPLICATION

The disclosure of Japanese Patent Application No. 2003-369479 filed on Oct. 29, 2003 including specification, drawings and claims and the disclosure of Japanese Patent Application No. 2003-383437 filed on Nov. 13, 2003 including specification, drawings and claims are incorporated herein by reference in its entity.

### BACKGROUND OF THE INVENTION

1. Technical Field to which the Invention Belongs

The present invention relates to a method for supporting a reflector in an optical scanner, an optical scanner, and an image formation apparatus including the optical scanner.

2. Prior Art

Conventionally, optical scanners have been used for image formation apparatuses such as laser beam printers, laser facsimile machines and digital copy machines. As an optical scanner of this kind, an apparatus including a semiconductor laser as a light source, a polygon mirror (rotating polygon mirror), a first image formation optical system for making a ray bundle from the semiconductor laser form a line image on the polygon mirror, a second image formation optical system for forming an image of a uniform spot at a uniform velocity on a scanning plane, a scanning start signal detector for detecting the ray bundle scanned by the polygon mirror, and a detection optical system for gathering ray bundles from the semiconductor laser to the scanning start signal detector has been known (see, e.g., Japanese Laid-Open Publication No. 2001-166239, which will be hereinafter referred to as “Patent Reference 1”).

As described above, the second image formation optical system exerts the high level function of forming an image of a uniform spot at a uniform velocity on a scanning plane. Therefore, when it is intended to form the second image formation optical system of a single optical element, the optical element has to be formed into a complicated shape. In many cases, a glass lens, i.e., a light transmission type optical element, is used in the second image formation optical system. However, it is difficult to process a glass lens into a complicated shape and thus it is difficult to form the second image formation optical system of a single glass lens. Therefore, when the second image formation optical system is to be formed of glass lenses, a plurality of glass lenses have to be combined. Such a combination of lenses is normally called fθ lens.

Glass lenses are, however, of an expensive optical element. When the second image formation optical system is formed of glass lenses, a plurality of expensive glass lenses are needed. Therefore, it has been difficult to reduce the size of and costs for optical scanners.

To reduce the size of and costs for optical scanners, then, an apparatus using a reflector in which a reflection plane of a curved plane is provided in the second image formation system has been proposed. That is, use of not a light transmission type optical element but a light reflex type optical element as the second image formation optical system has been proposed.

Moreover, the present applicants have proposed that a reflector including a reflection plane of free-form surface is used to form the second image formation optical system of only the reflector (see, e.g., Japanese Laid-open Publication No. 2002-148539). As shown in FIG. 12, in a reflector 100 of this kind, a transverse plane has an approximate C shape and, on the other hand, the shape of the transverse plane is not constant along the axis direction but the entire reflector 100 is twisted. With such a shape, the reflector 100 can scan spots in straight line on a scanning plane.

In recent years, the size of optical scanners has been reduced more and more and influences of a vibration on an optical element have become a problem which can not be ignored. A reflector as an optical element is more easily influenced by a vibration than a light transmission type optical element (e.g., a lens). Therefore, measures to suppress influences of a vibration on a reflector are desired to be devised.

In the scanning optical apparatus of Patent Reference 1, as shown in FIGS. 13A and 13B, in order to suppress influences of a vibration, support members 102, 103, and 104 are provided under both end and center portions of the reflector 101 in the long side direction, respectively, to support the reflector 101 at three points in the end portions and the center portion. Furthermore, at each of the end potions, the reflector 101 is pressed by an elastic member (not shown) in the orthogonal direction to a reflection plane 105. On the other hand, at the center portion, the reflector 101 is pressed by an elastic member 106 in the parallel direction to the reflection plane 105. In this apparatus, the three support members 102, 103, and 104 for supporting the reflector 101 are arranged in an approximately straight line along the long side direction.

However, as shown in FIG. 13B, assume that the center of gravity G and support point S of the reflector 101 do not match each other in the front-rear direction of the reflector 101 (i.e., in the left-right direction in FIG. 13B). With an external force applied, the reflector 101 easily vibrates with the support point S as a center.

Moreover, in the scanning optical apparatus, the reflection plane 105 of the reflector 101 is not a curved plane but a flat plane. A cross section of the reflector 101 has a rectangular shape such that the reflector 101 is easily supportable. Thus, by the above-described supporting method in which the support points S align approximately linearly, vibration of the reflector 101 can be suppressed. Furthermore, in the reflector 101, the shape of the cross section is constant along the long side direction. Therefore, the shape of the reflector 101 is relatively simple and the reflector 101 originally has an easily supportable shape.

In contrast, the shape of a reflector having a reflection plane of a curved plane is complicated. Therefore, the above-described supporting method can not be used as it is and it has been desirable to develop new supporting methods.

Moreover, the reflector of Patent Reference 1 is merely a so-called deflecting mirror and the reflector itself can not form the second image formation optical system. However, especially in a reflector having a reflection plane of a so-called free-form surface, the entire reflector is formed in a twist shape. Therefore, it has been difficult to sufficiently suppress a vibration.

In view of the above-described points, the present invention has been devised and it is therefore an object of the present invention to support, in an optical scanner, a reflector including a reflection plane of a curved plane so that influences of a vibration is suppressed. Moreover, it is also an object of the present invention to provide an optical scanner which allows such a supporting method and an image formation apparatus including the optical scanner.

### SUMMARY OF THE INVENTION

A method for supporting a reflector according to the present invention is a method for supporting, in an optical scanner including a reflector for reflecting a ray bundle to be scanned, the reflector, in which the reflector includes a reflection plane formed of a curved plane having a long side extending in the scanning direction in which a ray bundle is scanned and having a positive power at least in the scanning direction, and the reflector is supported at a first support point located in the vicinity of one end of the reflector in the long side direction, a second support point located in the vicinity of the other end of the reflector in the long side direction, and a third support point located in the vicinity of a center of the reflector in the long side direction so as to be more toward a concave side of the reflection plane than an imaginary straight line joining the first support point and the second support point.

According to the method, a reflector is stably supported at three points which are not located in a straight line, so that the reflector can be stably supported. Moreover, a third support point is located so as to be more toward a concave side of a reflection plane than an imaginary straight line joining a first support point and a second support point. Thus, the first, second and third support points are arranged along the curve direction so as to correspond to the reflection plane being curved. Accordingly, the reflector is supported in a manner according to the shape of the reflector, so that the reflector is more stably supported. Furthermore, the third support point is located off the imaginary straight line. Thus, even if the reflector receives an external force, the reflector is prevented from rotating with respect to the imaginary straight line. Moreover, a twist of the reflector can be suppressed. As a result, an optical scanner in which influences of a vibration can be suppressed and which is hardly influenced by a vibration can be achieved.

It is preferable that a distance between the third support point and the imaginary straight line is larger than a sag of the reflection plane in the scanning direction.

Thus, the area of the imaginary triangle joining the first, second and third support points is increased and that the reflector can be stably supported.

It is preferable that first, second and third corresponding points located in parts of an opposite side of the reflector to a side in which the first, second and third support points are located and approximately corresponding to the first, second and third support points, respectively, are pressed toward the first, second and third support points, respectively.

Note that a point approximately corresponding to a support point may be a point (corresponding point) located in the opposite side to a side in which the support point is located and also may be a point in the vicinity of the corresponding point.

Thus, the reflector is sandwiched between each of the support points and its corresponding point. As a result, the reflector can be firmly supported.

It is preferable that the reflector includes a thin-plate-shaped reflector body of which one plane serves as a reflection plane and a rib extending from a back side of the reflection plane of the reflector body in the back side direction and having a long side extending in the scanning direction, and the third corresponding point is located on the rib.

Thus, the strength of the reflector is improved. Moreover, when the reflector is formed of a resin or like material, it is preferable, in order to suppress the generation of a sink of the material and improve accuracy in processing of the reflector, that the reflector has a smaller thickness. With the reflector, the strength of the reflector can be ensured by the rib. Therefore, the thickness of the reflector body can be reduced.

It is preferable that the reflector includes, with the third support point as a boundary, a first portion including the first support point and a second portion including the second support point, the center of gravity of the first portion is located on an imaginary straight line joining between the first support point and the third support point, and the center of gravity of the second portion is located on an imaginary straight line joining the second support point and the third support point.

Thus, the center of gravity of each portion is located on each imaginary straight line joining one support point and another, so that the reflector is hardly twisted even when the reflector receives an external force. Therefore, a face tangle error of the reflection plane hardly occurs.

It is preferable that the reflector includes, with the third support point as a boundary, a first portion including the first support point and a second portion including the second support point, a shear center of a cross section of the reflector in a center portion of the first portion in the long side direction is located on the imaginary straight line joining the first support point and the third support point, and a shear center of a cross section of the reflector in a center portion of the second portion in the long side direction is located on the imaginary straight line joining the second support point and the third support point.

Thus, the reflector is hardly twisted. Therefore, a face tangle error hardly occurs.

It is preferable that a center of gravity of the first portion approximately matches the shear center of the cross section of the reflector in the center portion of the first portion in the long side direction, and a center of gravity of the second portion approximately matches the shear center of the cross section of the reflector in the center portion of the second portion in the long side direction.

Thus, the reflector is even hardly twisted. Therefore, a face tangle error even hardly occurs.

It is preferable that a depth of the center portion of the reflector is larger than a depth of each of end portions of the reflector.

Thus, the third support point, i.e., a support point in an approximately center portion can be made to be located in a further back side. Accordingly, the area of a triangle joining the first, second and third support points can be increased, so that the reflector can be more stably supported.

It is preferable that a second moment of area in the center portion of the reflector is larger than a second moment of area in each of the end potions of the reflector.

Thus, the strength of the reflector is stronger in the center portion than in each of the end portions. Therefore, even when thermal expansion occurs in the reflector, the reflector can easily stretch along the long side direction from the center portion. Accordingly, a twist deformation due to thermal expansion in the thickness direction (i.e., the approximately orthogonal direction with the long side direction) is hardly generated, so that a face tangle error hardly occurs.

It is preferable that an area of a cross section of the reflector in the vicinity of each of the support points is larger than an area of a cross section of the reflector in a portion located between one of the support points and another.

Thus, compared to the vicinity of each support point, the weight of a portion of the reflector located between one support point and another is reduced. Therefore, even when an external force is applied to the reflector, an inertial force is hardly generated in the portion between one support point and another, compared to the vicinity of each support point. On the other hand, the vicinity of each support point is supported. Thus, a vibration hardly occurs in the first place. Therefore, a vibration of the reflector is suppressed.

An optical scanner according to the present invention includes: a light source for outputting a ray bundle; an optical deflector for scanning the ray bundle from the light source; a first image formation optical system, arranged between the light source and the optical deflector, for leading the ray bundle from the light source to a deflecting plane of the optical deflector and for forming a line image on the deflecting plane; and a second image formation optical system, arranged between the optical deflector and a scanning plane to be scanned, for leading the ray bundle from the optical deflector to the scanning plane and forming an image of a uniform spot on the scanning plane at a uniform velocity. In the optical scanner, the second image formation optical system includes a reflector having a reflection plane formed of a curved plane which has a long side extending in the scanning direction in which the ray bundle is scanned and a positive power at least in the scanning direction, and the optical scanner further includes a support member for supporting the reflector at a first support point located in the vicinity of one end of the reflector in the long side direction, a second support point located in the vicinity of the other end of the reflector in the long side direction, and a third support point located in the vicinity of a center of the reflector in the long side direction so as to be more toward a concave side of the reflector plane than an imaginary straight line joining the first support point and the second support point.

It is preferable that a distance between the third support point and the imaginary straight line is larger than a sag of the reflection plane in the scanning direction.

It is preferable that the optical scanner further includes: a pressure member for pressing first, second and third corresponding points located in parts of an opposite side of the reflector to a side in which the first, second and third support points are located and approximately corresponding to the first, second and third support points, respectively, toward the first, second and third support points, respectively.

It is preferable that the reflector includes a thin-plate-shaped reflector body of which one plane serves as a reflection plane and a rib extending from a back side of the reflection plane of the reflector body in the back side direction and having a long side extending in the scanning direction, and the third corresponding point is located on the rib.

It is preferable that the reflector includes, with the third support point as a boundary, a first portion including the first support point and a second portion including the second support point, the center of gravity of the first portion is located on an imaginary straight line joining between the first support point and the third support point, and the center of gravity of the second portion is located on an imaginary straight line joining the second support point and the third support point.

It is preferable that the reflector includes, with the third support point as a boundary, a first portion including the first support point and a second portion including the second support point, a shear center of a cross section of the reflector in a center portion of the first portion in the long side direction is located on the imaginary straight line joining the first support point and the third support point, and a shear center of a cross section of the reflector in a center portion of the second portion in the long side direction is located on the imaginary straight line joining the second support point and the third support point.

It is preferable that a center of gravity of the first portion approximately matches the shear center of the cross section of the reflector in the center portion of the first portion in the long side direction, and a center of gravity of the second portion approximately matches the shear center of the cross section of the reflector in the center portion of the second portion in the long side direction.

It is preferable that a depth of the center portion of the reflector is larger than a depth of each of end portions of the reflector.

It is preferable that a second moment of area in the center portion of the reflector is larger than a second moment of area in each of the end potions of the reflector.

It is preferable that an area of a cross section of the reflector in the vicinity of each of the support points is larger than an area of a cross section of the reflector in a portion located between one of the support points and another.

It is preferable that the reflector includes a synthetic resin member having a curved plane and a mirror surface film formed on the curved plane of the synthetic resin member.

Thus, the synthetic resin member can be processed in a simple manner and even a curved plane having a complex shape can be formed in a relatively simple manner. Moreover, the synthetic resin member can be formed at low cost, compared to a glass member.

It is preferable that the second formation optical system is formed of only the reflector.

The reflection surface of the reflector is formed of a free-form surface, so that the second image formation optical system can be formed of only the reflector. Therefore, in the optical scanner, even a reflector including a reflection plane formed of a free-form surface can be stably supported.

An image formation apparatus according to the present invention includes: an optical scanner; an approximately cylindrical photosensitive body having a rim surface to serve as a scanning plane to be scanned and extending in the scanning direction in which a ray bundle is scanned in the optical scanner; driving mechanism for rotating the photosensitive body; a developer for supplying toner to the photosensitive body; and transferer for transferring a toner image formed on the photosensitive body to a recording medium. In the apparatus, the optical scanner includes a light source for outputting a ray bundle, an optical deflector for scanning a ray bundle from the light source, a first image formation optical system, arranged between the light source and the optical deflector, for leading the ray bundle from the light source to a deflecting plane of the optical deflector and for forming a line image on the deflecting plane, and a second image formation optical system, arranged between the optical deflector and a scanning plane to be scanned, for leading the ray bundle from the optical deflector to the scanning plane and forming an image of a uniform spot on the scanning plane at a uniform velocity, the second image formation optical system includes a reflector having a reflection plane formed of a curved plane which has a long side extending in the scanning direction in which the ray bundle is scanned and a positive power at least in the scanning direction, and the optical scanner further includes a support member for supporting the reflector at a first support point located in the vicinity of one end of the reflector in the long side direction, a second support point located in the vicinity of the other end of the reflector in the long side direction, and a third support point located in the vicinity of a center of the reflector in the long side direction so as to be more toward a concave side of the reflector plane than an imaginary straight line joining the first support point and the second support point.

Thus, an image formation apparatus which is hardly influenced by a vibration can be achieved.

Another method for supporting a reflector according to the present invention is a method for supporting, in an optical scanner including a reflector for reflecting a ray bundle to be scanned, the reflector, in which the reflector includes a reflection plane formed of a curved plane having a long side extending in the scanning direction in which a ray bundle is scanned and having a positive power at least in the scanning direction, and the reflector is supported at first, second and third support points arranged so as to surround a center of gravity of the reflector when viewed from the top.

According to the method, the center of gravity of the reflector is located inside of an imaginary triangle joining the first, second and third support points. Thus, even when an external force is applied, the reflector receives, at any one of the support points, a force in the opposite direction to the direction of a vibration. Therefore, a vibration of the reflector is suppressed.

Still another method for supporting a reflector according to the present invention is a method for supporting, in an optical scanner including a reflector for reflecting a ray bundle to be scanned, the reflector, in which the reflector includes a reflection plane formed of a curved plane having a long side extending in the scanning direction in which a ray bundle is scanned and having a positive power at least in the scanning direction, and the reflector is supported at first, second and third support points arranged so as to surround a shear center of a cross section of the reflector in a center portion of the reflector when viewed from the top.

According to the method, the shear center of a cross section of the reflector in the center portion is located inside of an imaginary triangle joining the first, second and third support points. Thus, even when an external force is applied, at least a portion of the reflector located in the center portion is hardly twisted. Therefore, a face tangle error of the reflection plane hardly occurs, so that influences of a vibration are suppressed.

It is preferable that the first and second support points are located in the vicinity of one end of the reflector in the long side direction, and the third support point is located in the vicinity of the other end of the reflector in the long side direction.

According to the method, each of the first, second and third support points is located in an end portion of the reflector. Thus, in part of the reflector other than the end portions, the generation of distortion due to being supported is suppressed. Therefore, in other part of the reflection plane other than the end portions, a face tangle error is effectively suppressed.

The first support point may be located in the vicinity of one end portion of the reflector in the long side direction, the second support point may be located in the vicinity of the other end of the reflector in the long side direction, and the third support point may be located in the vicinity of the center portion of the reflector in the long side direction.

According to the method, a distance between one support point and another is relatively uniform. Thus, the reflector is more stably supported.

It is preferable that the third support point is located so as to be more toward a concave side of the reflection plane of the reflector than an imaginary straight line joining the first support point and the second support point.

Thus, the first, second and third support points are arranged along the curve direction so as to correspond to a reflection plane being curved. Therefore, the reflector is supported according to the shape of the reflector plane, so that the reflector can be more stably supported.

It is preferable that the center of gravity of the reflector matches a shear center of a cross section of the reflector in a center portion of the reflector in the long side direction.

Thus, a vibration and a twist of the reflector are suppressed, so that a face tangle error of the reflection plane is suppressed furthermore.

It is preferable that the reflector is formed so that a front portion of the reflector in which the reflection plane is formed and a rear portion of the reflector located in a back side of the reflection plane are symmetrical to each other with respect to a plane including the middle of the reflector in the front-rear direction and having the long side direction of the reflector and the support direction of each of the support points.

Thus, the reflector is formed so as to have a form with which the reflector is stably supportable. Therefore, the reflector is more stably supported.

Another optical scanner according to the present invention includes: a light source for outputting a ray bundle; an optical deflector for scanning the ray bundle from the light source; a first image formation optical system, arranged between the light source and the optical deflector, for leading the ray bundle from the light source to a deflecting plane of the optical deflector and for forming a line image on the deflecting plane; and a second image formation optical system, arranged between the optical deflector and a scanning plane to be scanned, for leading the ray bundle from the optical deflector to the scanning plane and forming an image of a uniform spot on the scanning plane at a uniform velocity. In the optical scanner, the second image formation optical system includes a reflector having a reflection plane formed of a curved plane which has a long side extending in the scanning direction in which the ray bundle is scanned and a positive power at least in the scanning direction, the optical scanner further includes first, second and third support members for supporting the reflector at first, second and third support points, respectively, and a center of gravity of the reflector is located inside of an imaginary triangle joining the first, second and third support points when viewed from the top.

Still another optical scanner according to the present invention includes: a light source for outputting a ray bundle; an optical deflector for scanning the ray bundle from the light source; a first image formation optical system, arranged between the light source and the optical deflector, for leading the ray bundle from the light source to a deflecting plane of the optical deflector and for forming a line image on the deflecting plane; and a second image formation optical system, arranged between the optical deflector and a scanning plane to be scanned, for leading the ray bundle from the optical deflector to the scanning plane and forming an image of a uniform spot on the scanning plane at a uniform velocity. In the optical scanner, the second image formation optical system includes a reflector having a reflection plane formed of a curved plane which has a long side extending in the scanning direction in which the ray bundle is scanned and a positive power at least in the scanning direction, the optical scanner further includes first, second and third support members for supporting the reflector at first, second and third support points, respectively, and a shear center of a cross section of the reflector in a center portion of the reflector in the long side direction is located inside of an imaginary triangle joining the first, second and third support points when viewed from the top.

It is preferable that the first and second support points are located in the vicinity of one end of the reflector in the long side direction, and the third support point is located in the vicinity of the other end of the reflector in the long side direction.

The first support point may be located in the vicinity of one end of the reflector in the long side direction, the second support point may be located in the vicinity of the other side of the reflector in the long side direction, and the third support point may be located in the vicinity of a center portion of the reflector in the long side direction.

It is preferable that the third support point is located so as to be more toward a concave side of the reflection plane of the reflector than an imaginary straight line joining the first support point and the second support point.

It is preferable that the center of gravity of the reflector matches a shear center of a cross section of the reflector in the center portion of the reflector in the long side direction.

It is preferable that the reflector is formed so that a front portion of the reflector in which the reflection plane is formed and a rear portion of the reflector which is located in a back side of the reflection plane are symmetrical to each other with respect to a plane including the middle of the reflector in the front-rear direction and having the long side direction of the reflector and the support direction of each of the support points.

It is preferable that the reflector includes a synthetic resin member having a curved plane and a mirror surface film formed on the curved plane of the synthetic resin member.

Thus, the synthetic resin member can be processed in a simple manner and even a curved plane having a complex shape can be formed in a relatively simple manner. Moreover, the synthetic resin member can be formed at low cost, compared to the case in which a glass member.

It is preferable that the second formation optical system is formed of only the reflector.

The reflection surface of the reflector is formed of a free-form surface, so that the second image formation optical system can be formed of only the reflector.

Another image formation apparatus according to the present invention incluudes: an optical scanner; an approximately cylindrical photosensitive body having a rim surface to serve as a scanning plane and extending in the scanning direction in which a ray bundle is scanned in the optical scanner; driving mechanism for rotating the photosensitive body; a developer for supplying toner to the photosensitive body; and transferer for transferring a toner image formed on the photosensitive body to a recording medium. In the apparatus, the optical scanner includes a light source for outputting a ray bundle, an optical deflector for scanning a ray bundle from the light source, a first image formation optical system, arranged between the light source and the optical deflector, for leading the ray bundle from the light source to a deflecting plane of the optical deflector and for forming a line image on the deflecting plane, and a second image formation optical system, arranged between the optical deflector and a scanning plane to be scanned, for leading the ray bundle from the optical deflector to the scanning plane and forming an image of a uniform spot on the scanning plane at a uniform velocity, the second image formation optical system includes a reflector having a reflection plane formed of a curved plane which has a long side extending in the scanning direction in which the ray bundle is scanned and a positive power at least in the scanning direction, and the optical scanner further includes first, second and third support members for supporting the reflector at first, second and third support points, respectively, and a center of gravity of the reflector is located inside of an imaginary triangle joining the first, second and third support points when viewed from the top.

Thus, an image formation apparatus which is hardly influenced by a vibration can be achieved.

Still another image formation apparatus includes: an optical scanner; an approximately cylindrical photosensitive body having a rim surface to serve as a scanning plane and extending in the scanning direction in which a ray bundle is scanned in the optical scanner; driving mechanism for rotating the photosensitive body; a developer for supplying toner to the photosensitive body; and transferer for transferring a toner image formed on the photosensitive body to a recording medium. In the apparatus, the optical scanner includes a light source for outputting a ray bundle, an optical deflector for scanning a ray bundle from the light source, a first image formation optical system, arranged between the light source and the optical deflector, for leading the ray bundle from the light source to a deflecting plane of the optical deflector and for forming a line image on the deflecting plane, and a second image formation optical system, arranged between the optical deflector and a scanning plane to be scanned, for leading the ray bundle from the optical deflector to the scanning plane and forming an image of a uniform spot on the scanning plane at a uniform velocity, the second image formation optical system includes a reflector having a reflection plane formed of a curved plane which has a long side extending in the scanning direction in which the ray bundle is scanned and a positive power at least in the scanning direction, and the optical scanner further includes first, second and third support members for supporting the reflector at first, second and third support points, respectively, and a shear center of a cross section of the reflector in a center portion of the reflector in the long side direction is located inside of an imaginary triangle joining the first, second and third support points when viewed from the top.

Thus, an image formation apparatus which is hardly influenced by a vibration can be achieved.

### EFFECTS OF THE INVENTION

According to the present invention, a reflector is supported at end portions of the reflector and also at a point which is located in the vicinity of a center portion of the reflector so as to be more toward a concave side of a reflection plane than an imaginary straight line joining respective supporting points in the end portions. Thus, even with the reflection plane curved from the long side direction of the reflector, the reflector is stably supported, so that a vibration can be suppressed.

If corresponding portions of the reflector located in the opposite side of the reflector to a side thereof in which the support points are located are pressed, the reflector can be more stably supported.

By providing a rib extending in a back side of a reflector body, the strength of the reflector can be improved. Moreover, the strength is ensured by the rib, and thus the reflector body can be formed so as to have a small thickness. Therefore, accuracy in processing the reflection plane can be improved.

If the center of gravity of a portion of the reflector located between one of the support points and another is located on an imaginary straight line joining one of the support points and another, a twist of the reflector can be suppressed, so that a face tangle error of the reflection plane can be suppressed. Moreover, if the center of gravity of the reflector and the shear center of a cross section of the reflector can be made to match each other, distortion of the reflector can be effectively suppressed.

By setting the depth of the center portion of the reflector to be longer than that of each of the end portions, the area of an imaginary triangle joining the first, second and third support points can be increased. Thus, the reflector can be more stably supported.

By setting a second moment of area of a cross section of the reflector in a center portion to be larger than that of each of the end portions, twist deformation of the reflector can be suppressed. Thus, a face tangle error of the reflection plane can be suppressed.

By setting the area of a cross section of the reflector in the vicinity of each of the support points to be larger than that of a portion of the reflector located between one of the support points and another, the weight of the portion located between one of the support points and another can be reduced, compared to the vicinity of each of the support points. Thus, a vibration can be effectively suppressed.

According to the present invention, the reflector is supported at three points so that the center of gravity of the reflector is located inside of an imaginary triangle joining the first, second and third support points when viewed from the top. Thus, influences of a vibration can be suppressed.

Moreover, by supporting the reflector at three points so that the shear center of a cross section of the reflector in the center portion is located inside of an imaginary triangle joining the first, second and third support points when viewed from the top, a twist caused due to a vibration can be suppressed. Thus, influences of a vibration can be suppressed.

If the first and second support points are located in the vicinity of one end of the reflector and the third support point is located in the vicinity of the other end of the reflector, a face tangle error in part of the reflector other than the end portions can be effectively suppressed.

If the first support point is located in the vicinity of one end of the reflector, the second support point is located in the vicinity of the other end of the reflector, and the third support point is located in the vicinity of a center point of the reflector, a distance between one of the support point and another can be made relatively uniform. Thus, the reflector can be stably supported.

If the third support point is located more toward a concave of the reflection plane than an imaginary straight line joining the first support point and the second support point. Thus, the reflector can be supported in a form according to the shape of a curve of the reflection plane.

By making the center of gravity of the reflector and the shear center of a cross section in the center portion match each other, a face tangle error of the reflector can be suppressed furthermore.

By forming the reflector so as to be symmetric in the front-rear direction, the reflector can be more stably supported.

### BRIEF DESCRIPTION OF THE DRAWINGS

FIG. 1 is a plan view of an optical scanner according to an embodiment of the present invention.

FIG. 2 is a perspective view illustrating a main portion of the optical scanner of the embodiment.

FIG. 3 is a perspective view illustrating an optical scanner and a photosensitive drum.

FIGS. 4A, 4B and 4C are explanatory illustrations of a reflector according to an embodiment: FIG. 4A is a plan view of the reflector; FIG. 4B is a front view thereof; and FIG. 4C is a side view thereof.

FIGS. 5A, 5B and 5C are explanatory illustrations of a reflector according to a modified example of the embodiment: FIG. 5A is a plan view of the reflector; FIG. 5B is a front view thereof; and FIG. 5C is a cross-sectional view thereof taken along the line V-V of FIG. 5B.

FIGS. 6A, 6B and 6C are explanatory illustrations of a reflector according to a modified example of the embodiment: FIG. 6A is a plan view of the reflector; FIG. 6B is a front view thereof; and FIG. 6C is a side view thereof.

FIGS. 7A, 7B and 7C are explanatory illustrations of a reflector according to a modified example of the embodiment: FIG. 7A is a plan view of the reflector; FIG. 7B is a front view thereof; and FIG. 7C is a cross-sectional view thereof taken along the line VII-VII of FIG. 7B.

FIGS. 8A, 8B and 8C are explanatory illustrations of a reflector according to an embodiment: FIG. 8A is a plan view of the reflector; FIG. 8B is a front view thereof; and FIG. 8C is a side view thereof.

FIGS. 9A, 9B and 9C are explanatory illustrations of a reflector according to a modified example of the embodiment: FIG. 9A is a plan view of the reflector; FIG. 9B is a front view thereof; and FIG. 9C is a side view thereof.

FIGS. 10A, 10B and 10C are explanatory illustrations of a reflector according to a modified example of the embodiment: FIG. 10A is a plan view of the reflector; FIG. 10B is a front view thereof; and FIG. 10C is a side view thereof.

FIG. 11 is a cross-sectional view schematically illustrating an image formation apparatus according to an embodiment of the present invention.

FIG. 12 is an explanatory illustration of a reflector having a reflection plane formed of a free-form plane.

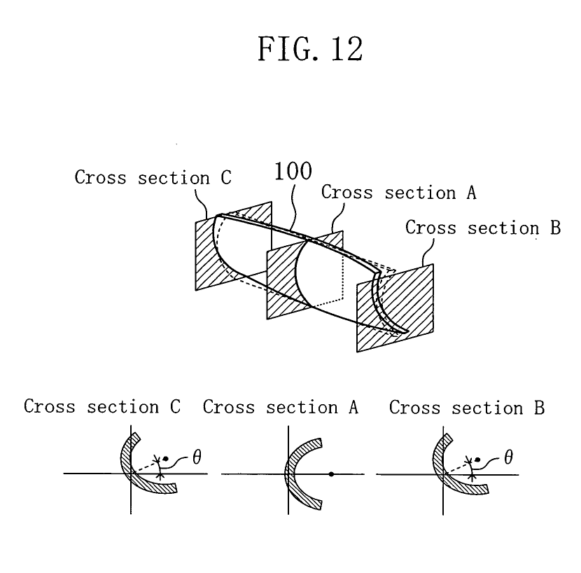

FIGS. 13A, 13B and 13C are explanatory illustrations of a known reflector according to a modified example of the embodiment: FIG. 13A is a plan view of the reflector; FIG. 13B is a front view thereof; and FIG. 13C is a cross-sectional view thereof taken along the line XIII-XIII of FIG. 13B.

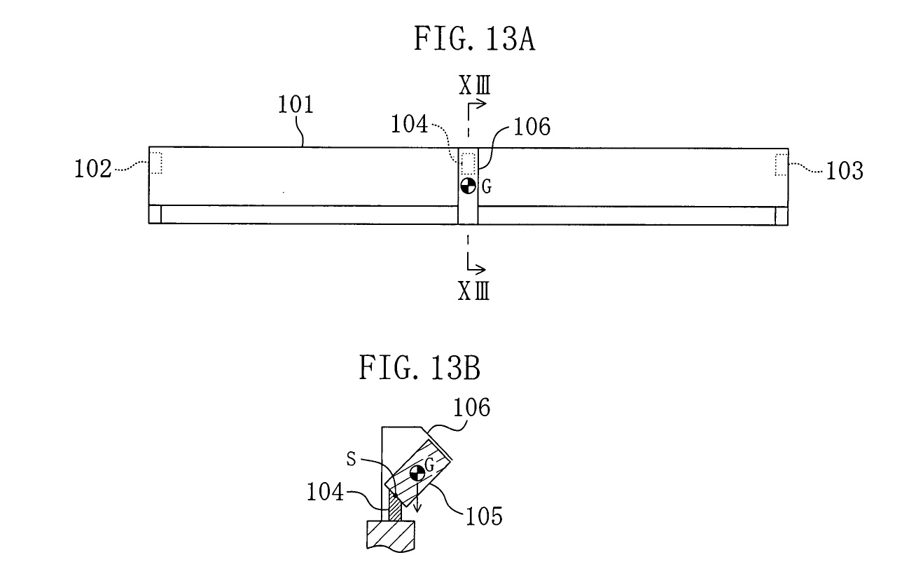

### DESCRIPTION OF THE PREFERRED EMBODIMENTS

Hereinafter, embodiments of the present invention will be described in detail with reference to the accompanying drawings.

### Embodiment 1

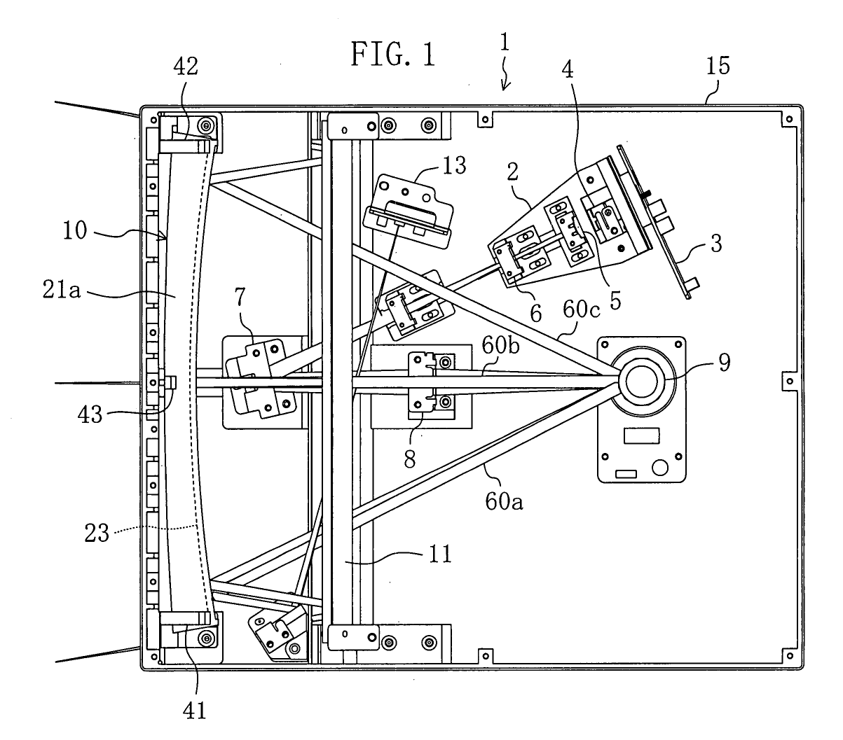

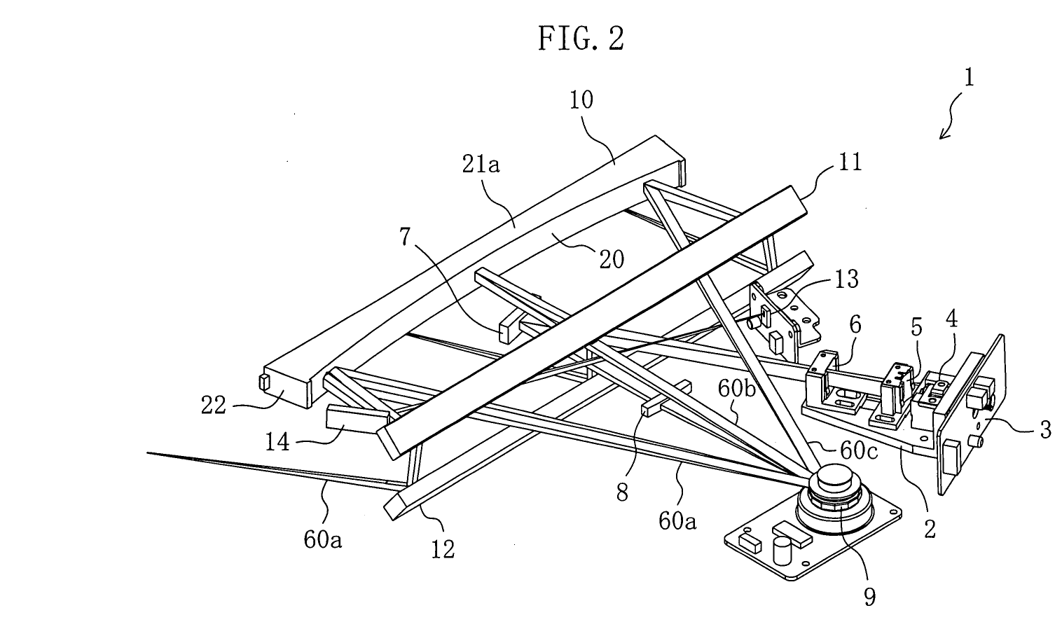

As shown in FIGS. 1 and 2, an optical scanner 1 according to this embodiment includes a light source unit 2, a polygon mirror 9, a reflector 10 and a synchronization sensor 13. These members are provided in a case 15. Note that the right hand side of FIG. 1 is referred to as a “rear side” and the left hand side of FIG. 1 is referred to as a “front side” for convenience.

The light source unit 2 is formed of an assembly of a laser driving substrate (which will be hereinafter referred to as a semiconductor laser) 3 in which a semiconductor laser circuit is provided, a collimator lens 4, a main concave cylinder lens 5 and a sub convex cylinder lens 6. In the direction in which laser light of the light source unit 2 is irradiated, i.e., in the front of the light source unit 2, a deflecting mirror 7 is provided. A main convex cylinder lens 8 is provided between the deflecting mirror 7 and the polygon mirror 9.

The collimator lens 4, the main concave cylinder lens 5, the sub convex cylinder lens 6, and the main concave cylinder lens 8 lead beam (a ray bundle) from the semiconductor laser 3 to a deflecting plane of the polygon mirror 9 and also together form a first image formation optical system for forming a line image on the deflecting plane. Note that in this application, an element such as the deflecting mirror 7 which merely reflects light by a flat plane thereof is not included in the image formation optical system.

The polygon mirror 9 is a rotating polygon mirror including a plurality of reflection planes (deflecting planes) and is rotary-driven by a motor (not shown). Due to a rotation of the polygon mirror 9, light reflected by the polygon mirror 9 is scanned in the following order: a beam 60a, a beam 60b and a beam 60c. Note that the three beams 60a, 60b and 60c are illustrated at the same time for convenience, but in an actual situation, a single beam is scanned in the long side direction of a reflector 10 at a time. The reflector 10 for reflecting a beam from the polygon mirror 9 is provided in the front of the deflecting mirror 7. Details of the reflector 10 will be described later.

As shown in FIG. 2, deflecting mirrors 11 and 12 are provided in the rear of the reflector 10. Each of the deflecting mirrors 11 and 12 is formed so as to have a long length. The deflecting mirror 12 is provided under the deflecting mirror 11. Then, a beam reflected by the reflector 10 is reflected by the deflecting mirrors 11 and 12 in this order and irradiated in the frontward direction.

In the rear of a start point in the scanning direction (the position of an end potion in the left hand side of FIG. 2) in the reflector 10, a deflecting mirror 14 for reflecting light only when a beam is located in the point is provided. Light reflected by the deflecting mirror 14 is entered into a synchronization sensor 13. That is, at a start time of scanning, light is entered into the synchronization sensor 13 and a start of scanning is detected.

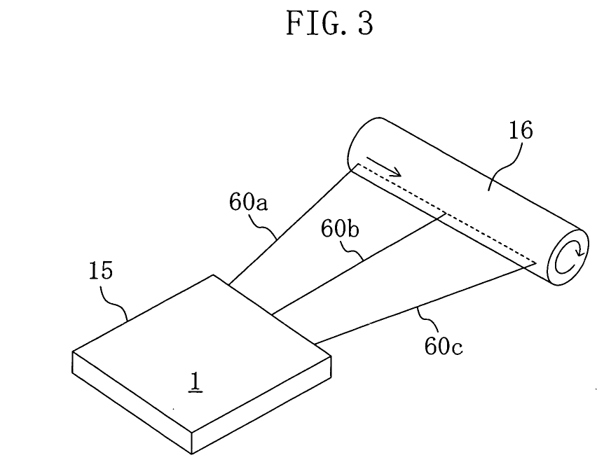

As shown in FIG. 3, a beam irradiated from the optical scanner 1 is lead onto a photosensitive drum 16 having a cylindrical shape. A rim surface of the photosensitive drum 16 forms a scanning plane on which a beam from the optical scanner is scanned and is covered with a photosensitive body in which charges vary when light is irradiated thereto. A beam from the optical scanner 1 is scanned, so that a beam spot is scanned on the photosensitive drum 16 in the parallel direction to the axis direction of the photosensitive drum 16 (i.e., a main scanning direction). The photosensitive drum 16 is rotary-driven by a motor, i.e., a driving mechanism (not shown). Thus, by a combination of scanning of a beam and rotation of the photosensitive drum 16, a two-dimensional latent image is formed on a surface of the photosensitive drum 16.

Next, the reflector 10 and a method for supporting the same will be described.

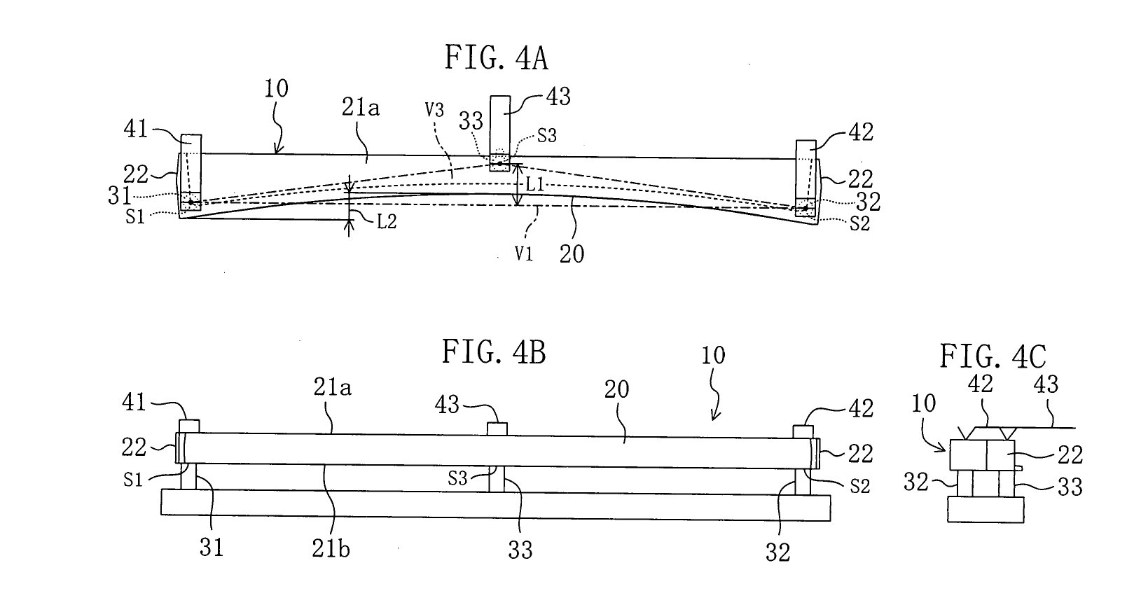

The reflector 10 forms a second image formation optical system for leading a beam from the polygon mirror 9 to a scanning plane of the photosensitive drum 16 and forming an image of a uniform spot at a uniform velocity on the scanning plane. As described above, the reflector 10 is formed so as to have a long side along the direction in which light is scanned. The reflector 10 includes a thin-plate-shaped reflector body 23 (see FIG. 1) having a reflection plane 20, upper and lower ribs 21a and 21b (see FIG. 4B) each extending from an upper or lower end of the reflector body 23 in the back side direction (i.e., the left hand side direction in FIG. 1 or, in other words, the front of the optical scanner 1), and end portion ribs 22 each extending to from a right or left end of the reflector body 23 in the back side direction and is formed as a unit by plastic resin. Note that each of the ribs 21a and 21b is formed so as to have a long side in the scanning direction as the reflector body 23.

A metal layer is formed on one plane (an obverse side plane) of the reflector body 23 and the metal layer forms the reflection plane 20 as a mirror surface. The reflection plane 20 is a curved plane having a long side in the direction in which a ray bundle is scanned and a positive power at least in the scanning direction. In other words, the reflector 20 is a curved plane which is curved in a concave arc at least so that a center portion of the plane in the long side direction is located more toward a back side with respect to the front-rear direction of the reflector 10 than each of end portions of the reflector 20. Also, the reflection plane 20 is a three-dimensional curved plane having an approximate C shaped lateral cross section and also an approximate C shaped longitudinal cross section. Furthermore, the reflection plane 20 is formed of a so-called free-form surface whose lateral cross section does not have a constant shape in the long side direction. This is because the second image formation optical system is formed of only the reflector 10. A specific shape of the reflection plane 20 can be appropriately set based on a distance between the optical scanner 1 and the photosensitive drum 16, a specification of each optical system and the like.

As shown in FIG. 4, the reflector 10 is supported by the first, second and third protrusions 31, 32 and 33 provided in the case 15 at three points in the end portions and center portion thereof. Specifically, the reflector 10 is supported at a first support point S1 located in the vicinity of one end of the reflector 10 in the long side direction, a second support point S2 located in the vicinity of the other end thereof, and a third support point S3 located around the center of the reflector 10. As shown in FIG. 4A, the third support point S3 is located more toward a concave side (the back side with respect to front-rear direction of the reflector 10) of the reflection plane 20 than an imaginary straight line V1 joining the first support point S1 and the second support point S2. In other words, the third support point S3 is located more toward a back side with respect to the front-rear direction of the optical scanner 1 than the imaginary straight line V1. Accordingly, the first support point S1, the third support point S3 and the second support point S2 are not arranged in line but along a curve shape of the reflector body 23.

To stably support the reflector 10, it is preferable that a distance L1 between the third support point S3 and the imaginary straight line V1 is set to be as long as possible. In this case, the distance L1 between the third support point S3 and the imaginary straight line V1 is larger than a sag L2 of the reflector body 23 in the scanning direction.

On parts of the reflector 10 corresponding to the first, second and third support points S1, S2 and S3, provided are first, second and third pressure springs 41, 42 and 43, respectively. Each of the corresponding parts may be directly on each of the first, second and third support points S1, S2 and S3 and also in the vicinity of each of the first, second and third support points S1, S2 and S3. Each of the pressure springs 41, 42 and 43 presses the reflector 10 in the downward direction. Therefore, the reflector 10 is sandwiched between each of the first, second and third pressure springs 41, 42 and 43 and each of the first, second and third protrusions 31, 32 and 33.

At the first, second and third support points S1, S2 and S3, the protrusions 31, 32 and 33 contact against the lower rib 21b. Moreover, the first, second and third pressure springs 41, 42 and 43 contact against the upper rib 21a. However, at the first and second support points S1 and S2, the protrusions 31 and 32 may contact against the reflector body 23. Also, the first and second pressure springs 41 and 42 may press against the reflector body 23. With the reflector body 23 pressed or supported at both of the end portions thereof, distortion might be caused in the vicinity of the pressed or supported portions of the reflector body 23. In this embodiment, however, both of the end portions of the reflector 10 are not used as reflection planes (i.e., light is not reflected at both of the end portions) and, therefore, actual problems hardly arise. By pressing or supporting the reflector body 23 at both of the end portions, the area of an imaginary triangle V3 joining the first, second and third support points S1, S2 and S3 or the area of an imaginary triangle joining the first, second and third pressure points can be increased. Thus, the reflector 10 can be stably supported.

In the optical scanner 1 of this embodiment, the reflector 10 is supported at three points, i.e., the first, second and third support points S1, S2 and S3 which are not arranged in a straight line and thus the reflector 10 is stably supported. Therefore, even when an external force (e.g., a vibration of the motor of the polygon mirror 9 and external impact) is applied to the reflector 10, the reflector 10 hardly vibrates and a face tangle error of the reflection plane 20 can be effectively prevented.

Specifically, in this embodiment, the distance L1 between the imaginary straight line V1 joining the first support point S1 and the second support point S2 and the third support point S3 is larger than the sag L2 of the reflection plane 20 in the scanning direction. Therefore, the reflector 10 can be stably supported.

Furthermore, the reflector 10 is pressed at the respective corresponding points to the first, second and third support points S1, S2 and S3. Thus, the reflector 10 can be more firmly held.

The reflector 10 is formed of a synthetic resin. Thus, even with the reflection plane 20 having a complicated shape, the reflection plane 20 can be achieved at low cost. Moreover, each of the ribs 21a, 21b and 22 is provided so as to extend from the reflector body 23 in the back side of the reflection plane 20. Thus, even if the reflector body 23 is formed so as to have a very small thickness, the strength of the entire reflector 10 can be maintained at a high level. By forming the reflector body 23 so as to have a small thickness, the generation of sinks of materials caused during processing can be suppressed. Therefore, processing accuracy for the reflector plane 20 can be improved.

At the third support point S3 and the pressure point corresponding to the third support point S3, the ribs 21a and 21b are supported and pressed. Thus, support and pressure forces do not directly affect the reflector body 23. Therefore, distortion in the reflection plane 20 to be generated as the center potion of the reflector 10 are supported and pressed can be suppressed.

As has been described, with the optical scanner 1, the reflector 10 including the reflection plane 20 formed of a free-form surface can be stably supported. The second image formation optical system is formed of only a reflection type optical element, originally, and thus the optical scanner 1 is easily influenced by a vibration in the first place, compared to an apparatus using a light transmission type optical element. However, in the optical scanner 1 of this embodiment, the reflector 10 can be stably supported and, therefore, a vibration of the reflector 10 can be suppressed at a high level. Accordingly, performance of the optical scanner 1 can be improved. Moreover, this can facilitate reduction in the size of optical scanners.

The shape of the reflector 10 and a method for supporting the reflector 10 are not limited to the above-described shape and supporting method. Next, modified examples for the shape of the reflector 10 and the method for supporting the reflector 10 will be described.

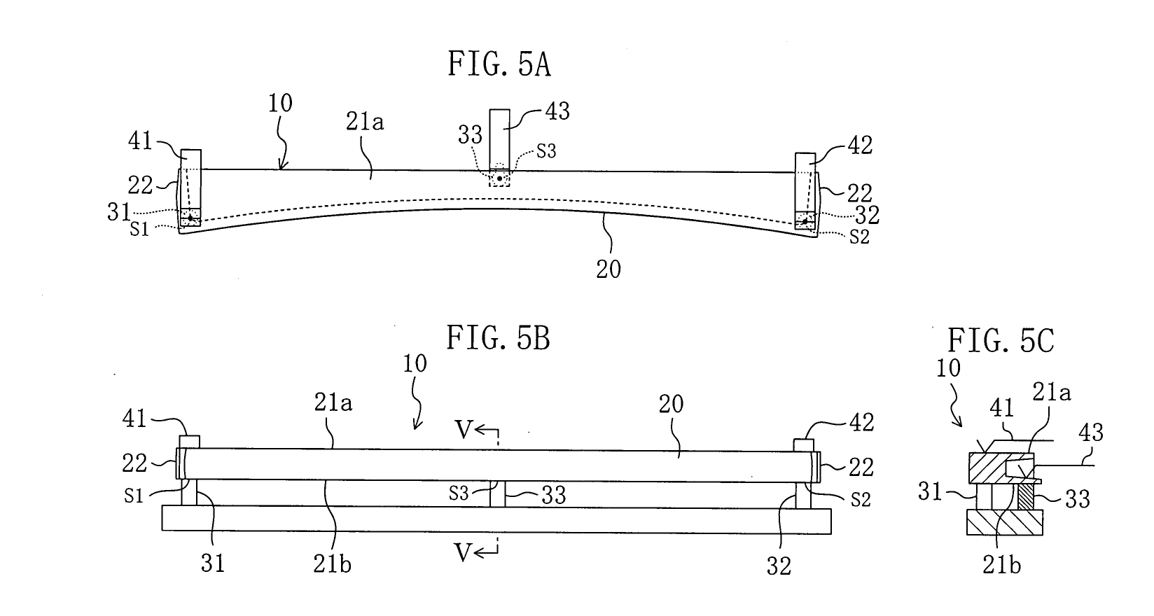

A modified example shown in FIGS. 5A, 5B and 5C is obtained by changing the pressure point at which pressure is applied by the third pressure spring 43. As shown in FIG. 5C, in this example, the third pressure spring 43 presses the lower rib 21b located in the center portion of the reflector 10. Thus, the pressure spring 43 presses the rib 21b itself supported by the protrusion 33. Accordingly, distortion in the reflector 10 due to a pressure force of the third pressure spring 43 can be suppressed.

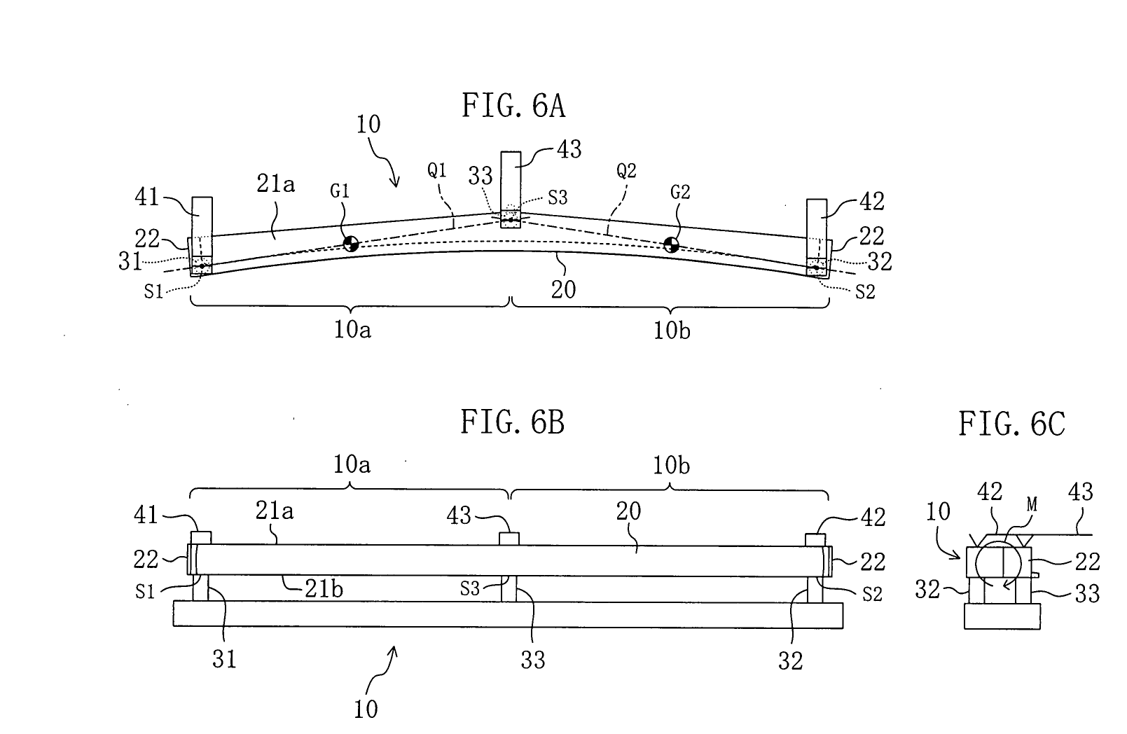

A modified example shown in FIG. 6 is obtained mainly by changing the shapes of the ribs 21a and 21b. The reflector 10 can be considered as a combination of two separate parts, i.e., right and left parts into which the reflector 10 is divided with the third support point S3 assumed to be a boundary. That is, the reflector 10 can be divided, with the third support point S3 as a boundary, into a first portion 10a located in the first support point S1 and a second portion 10b located in the second support point S2 side. In this example, the center of gravity G1 of the first portion 10a is located on an imaginary straight line Q1 joining the first support point S1 and the third support point S3. Moreover, the center of gravity G2 of the second portion 10b is located on an imaginary straight line Q2 joining the second support point S2 and the third support point S3. Note that “being located in a straight line” not only means to be located on a straight line in a strict sense but also being slightly shifted from a straight line. That is, the case where the center of gravity G1 or the center of gravity G2 can be considered to be substantially located on a straight line is included.

The reflector 10 is fixed by the protrusions 31, 32 and 33 and the pressure springs 41, 42 and 43. Thus, when a disturbance is applied to the reflector 10, with the reflector 10 fixedly supported at each of the support points S1, S2 and S3 and the pressure points corresponding to the support points S1, S2 and S3, a minute vibration of the reflector 10 is caused. In this case, an inertial force which acts in each member between the support points, i.e., the first potion 10a and the second portion 10b is considered to act in each of the centers of gravity G1 and G2. Therefore, if the centers of gravity G1 and G2 are located off the imaginary straight lines Q1 and Q2, respectively, a twist moment M (see FIG. 6C) which might cause a face tangle error of the reflection plane 20 is generated in the reflector 10. In this example, however, the centers of gravity G1 and G2 are located on the imaginary straight lines Q1 and Q2, respectively, the generation of such a twist moment M can be suppressed.

Note that in the modified examples, a shear center of a cross section at the center portion of the first portion 10a (i.e., a lateral cross section located at a middle point between a lateral cross section including the first support point S1 and a lateral cross section including the third support point S3) corresponds to the center of gravity G1 of the first portion 10a. Moreover, a shear center of a cross section at the center portion of the second potion 10b (i.e., a lateral cross section located at a middle point between a lateral cross section including the second support point S2 and a lateral cross section including the third support point S3) corresponds to the center of gravity G2 of the second portion 10b. Accordingly, the shear center of the cross section at the center portion of the first portion 10a is located on the imaginary straight line Q1 joining the first support point S1 and the third support point S3 and the shear center of the cross section at the center portion of the second portion 10b is located on the imaginary straight line Q2 joining the second support point S2 and the third support point S3. With the shear center of the cross section at the center portion of each of the first and second portions 10a and 10b located on the imaginary straight lines Q1 and Q2, respectively, distortion of the reflector 10 can be suppressed furthermore. Therefore, a face tangle error of the reflection plane 20 can be more effectively suppressed.

Moreover, in the modified example of FIG. 6, the area of a cross section in the vicinity of each of the support points S1, S2 and S3 is larger than the area of a cross section located between the first and third support points S1 and S3 and the area of a cross section located between the second and third support points S2 and S3. Accordingly, compared to the vicinity of each of the support points S1, S2 and S3, the weight of each portion between one of the support points and another is reduced. Thus, even when an external force is applied to the reflector 10, an inertial force is hardly generated in each portion between one of the support points and another, compared to the vicinity of each of the support points S1, S2 and S3. Therefore, each portion between one of the support points and another hardly vibrates, compared to the vicinity of each of the support portions. On the other hand, the vicinity of each of the support points S1, S2 and S3 is supported and therefore no vibration occurs in the vicinity of each of the support points S1, S2 and S3 in the first place. Therefore, according to this example, a vibration of the reflector 10 can be suppressed and a face tangle error of the reflection plane 20 can be effectively suppressed.

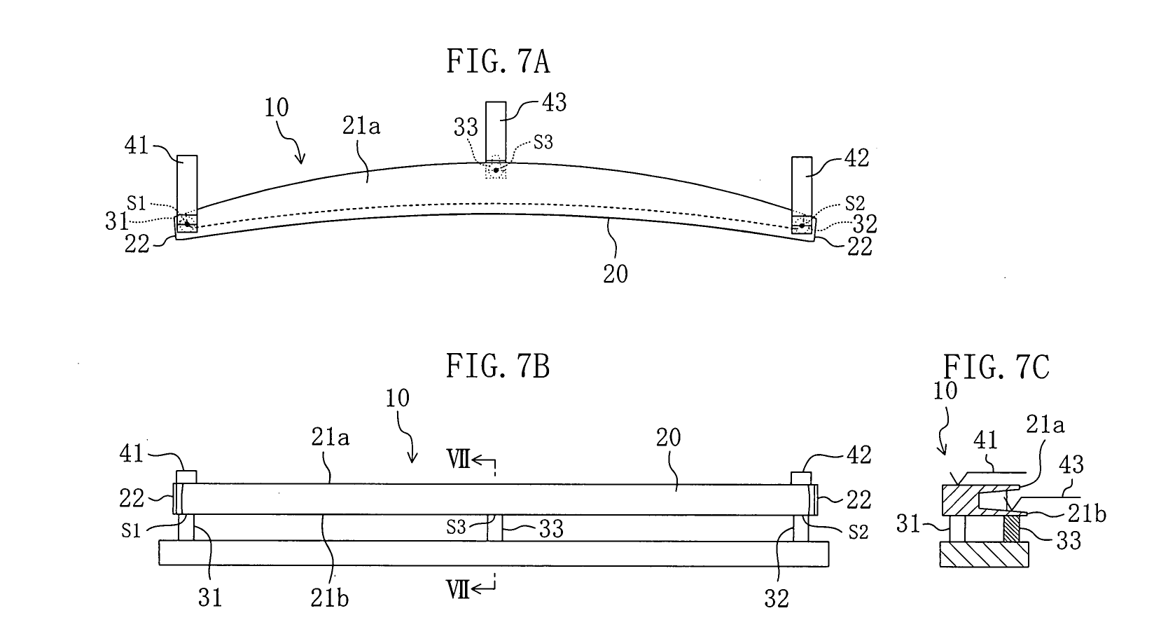

A modified example shown in FIG. 7 is obtained by changing the ribs 21a and 21b so that a depth of the center portion of the reflector 10 (i.e., a length in the up-down direction of an optical scanner of FIG. 7A) is larger than a depth of each of the end portions thereof. Moreover, in this example, the third pressure spring 43 presses the lower side rib 21b. In this example, the depth of each of the ribs 21a and 21b gradually decreases in the direction from the center potion of the reflector 10 to each of the end potions thereof. Therefore, the area of a lateral cross section of the reflector 10 is larger in the center portion than in each of the end portions. Moreover, a second moment of area in the lateral cross section of the reflector 10 is larger in the center portion than in each of the end portions.

According to this example, the center portion of the reflector 10 can be more firmly supported, so that a face tangle error of the reflection plane 20 in the center portion can be effectively prevented. Moreover, even when thermal expansion occurs in the reflector 10, the reflector 10 can easily stretch in the direction from the center portion to each of the end portions. Thus, a thermal stress in the reflector 10 is hardly generated. Accordingly, distortion due to a thermal stress is hardly generated and thus a twist of the reflector 10 can be suppressed. As a result, a face tangle error of the reflection plane 20 can be suppressed.

### Embodiment 2

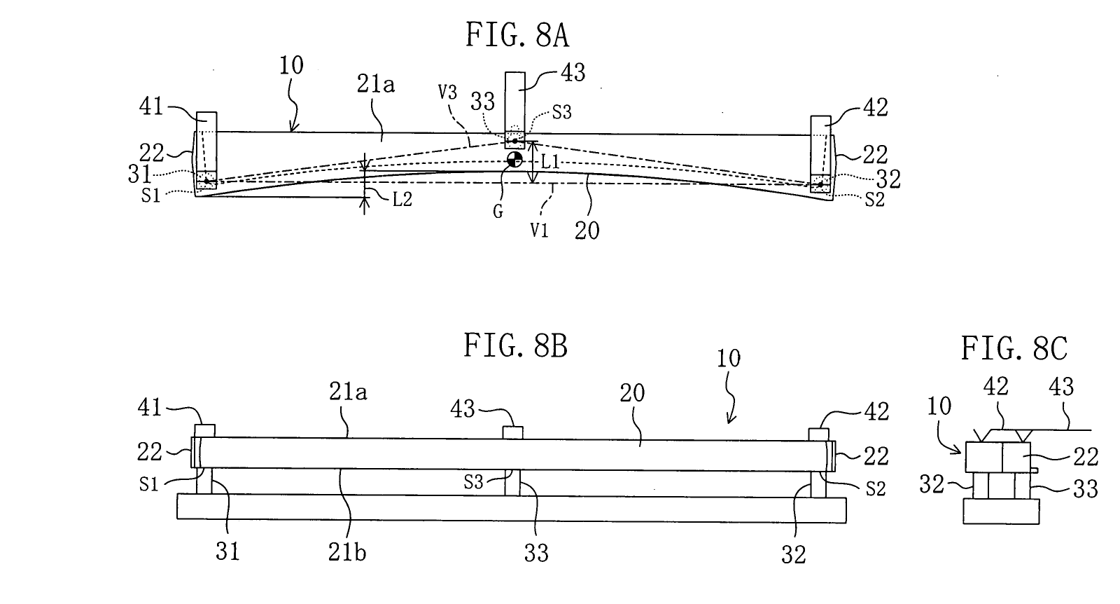

As shown in FIG. 8, in an optical scanner 1 according to this embodiment, the first, second and third support points S1, S2 and S3 are provided so that the center of gravity G of the reflector 10 is located inside of the imaginary triangle V3 joining the support points S1, S2 and S3 when viewed from the top. Moreover, although illustration is omitted, a shear center of a cross section of reflector 10 in the center potion in the long side direction is located inside of the imaginary triangle V3. In other points, the optical scanner of this embodiment is substantially the same as the optical scanner of EMBODIMENT 1.

As described above, in the optical scanner 1, the reflector 10 is supported so that the center of gravity G is located inside of the imaginary triangle V3 joining the support points S1, S2 and S3. Thus, even when an external force (e.g., a vibration of the motor of the polygon mirror 9 and external impact) is applied to the reflector 10, the reflector 10 receives a force in the reverse direction to the direction in which the reflector 10 vibrates. For example, when the reflector 10 receives an external force and is likely to rotate backward with respect to the imaginary straight line V1 joining the first support point S1 and the second support point S2, the reflector 10 receives from the support point 33 a force in the reverse direction to the direction in which the reflector 10 is likely to rotate. Thus, rotation of the reflector 10 is prevented. Therefore, with the optical scanner 1, even when an external force is applied to the reflector 10, the reflector 10 hardly vibrates and a face tangle error of the reflection plane 20 can be effectively suppressed.

Moreover, the shear center of a cross section of the reflector 10 in the center portion in the long side direction is also located inside of the imaginary triangle V3 joining the support points S1, S2 and S3. Thus, even when a force is applied to the reflector 10, a twist can be suppressed.

Specifically, in this embodiment, the reflector 10 is supported at three points, i.e., at the vicinity of each of the end portions and the vicinity of the center portion. Thus, a distance between one support point and another can be made uniform. Therefore, the reflector 10 can be stably supported.

Moreover, in this embodiment, the reflector 10 is pressed at points corresponding to the first, second and third support points S1, S2 and S3. Thus, the reflector 10 can be firmly held.

Moreover, the reflector 10 is formed of a synthetic resin. Thus, even when the reflection plane 20 has a complicated shape, the reflector plane 20 can be achieved at low cost. Moreover, the ribs 21a, 21b and 22 are provided so as to extend from the reflector body 23 in the back side of the reflection plane 20. Thus, even if the reflector body 23 is formed so as to have a very small thickness, the strength of the entire reflector 10 can be maintained at a high level. By forming the reflector body 23 so as to have a small thickness, the generation of sinks of materials caused during processing can be suppressed. Therefore, accuracy in processing the reflector plane 20 can be improved.

At the third support point S3 and the pressure point corresponding to the third support point S3, the ribs 21a and 21b are supported and pressed. Thus, support and pressure forces do not directly affect the reflector body 23. Therefore, distortion in the reflection plane 20 caused by supporting and pressing the center potion of the reflector 10 can be suppressed.

As has been described, in the optical scanner 1, the reflector 10 including the reflection plane 20 formed of a free-form surface can be stably supported. The second image formation optical system is formed of only a reflection type optical element, and thus the optical scanner 1 is easily influenced by a vibration, originally, compared to an apparatus using a light transmission type optical element. However, in the optical scanner 1 of this embodiment, the reflector 10 can be stably supported and, therefore, a vibration of the reflector 10 can be suppressed. Accordingly, performance of the optical scanner 1 can be improved. Moreover, this can facilitate reduction in the size of optical scanners.

The shape of the reflector 10 and a method for supporting the reflector 10 are not limited to the above-described shape and supporting method. Next, modified examples for the shape of the reflector 10 and the method for supporting the reflector 10 will be described.

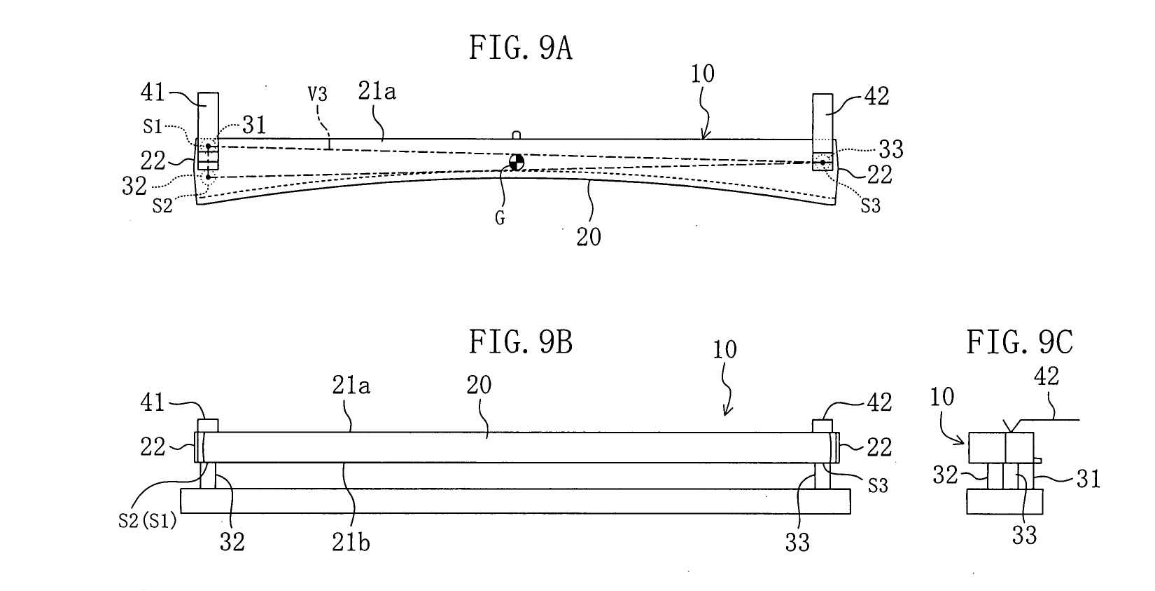

A modified example shown in FIG. 9 is obtained by changing the numbers and positions of support points and pressure points. Specifically, each of the first support point S1 and the second support point S2 is located in the vicinity of one end of the reflector 10 while the third support point S3 is located in the vicinity of the other end of the reflector 10. The first support point S1 and the second support point S2 are arranged in the front-rear direction (i.e., the up-down direction in FIG. 9A). In this example, the center of gravity G of the reflector 10 and the shear center (not shown) of a cross section of the reflector 10 in the center portion in the long side direction is located inside of the imaginary triangle V3 joining the support points S1, S2 and S3.

Accordingly, in this example, even when an external force is applied to the reflector 10, the reflector 10 hardly vibrates and also hardly twists at least in the center portion. Therefore, a face tangle error of the reflection plane 20 can be effectively suppressed.

In addition, according to this example, each of the first, second and third support points S1, S2 and S3 is located in the vicinity of an end potion of the reflector 10. Thus, in other part of the reflector 10 than the vicinity of each of the end portions, the generation of minute distortion to be locally generated due to a support force can be prevented. Note that in this example, part of the reflection plane 20 other than the end portions is used for reflection of light. Therefore, even if minute distortion due to a support force is generated in each of the end portions, no particular problem actually arises.

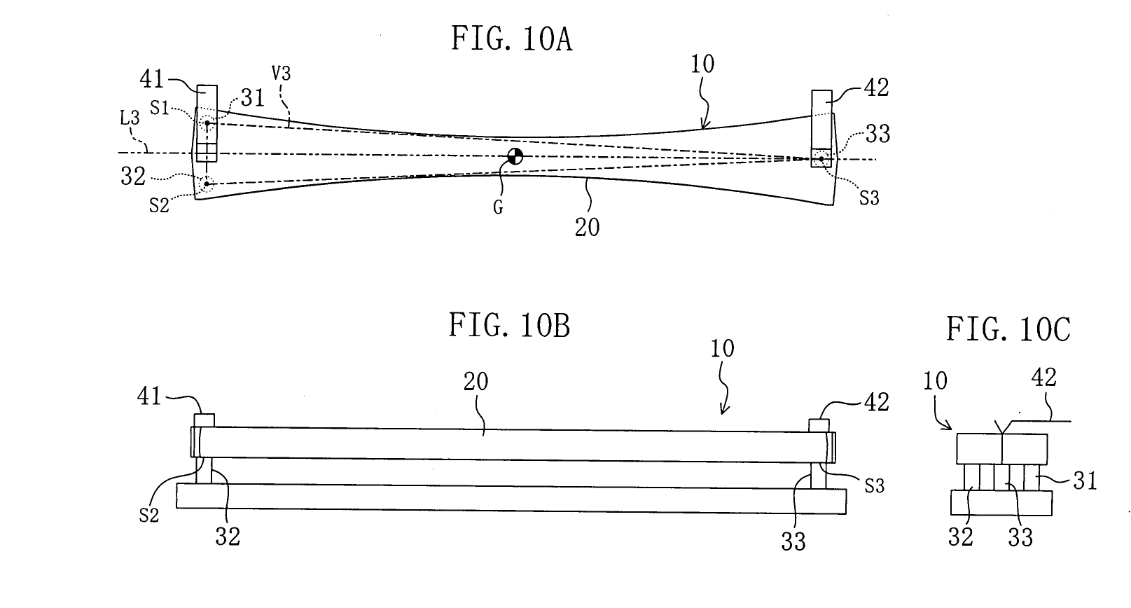

A modified example shown in FIG. 10 is obtained by further changing the shape of the reflector 10. The reflector 10 of this example is formed so as to be symmetric in the front-rear direction. Specifically, the reflector 10 is formed so that a front portion of the reflector 10 in which the reflection plane 20 is formed and a rear portion of the reflector 10 located in the back side of the reflection plane 20 are symmetrical to each other with respect to an imaginary plane L3 having the long side direction (i.e., the left-right direction of FIG. 10B) and the support direction of each of the support points S1, S2 and S3 (i.e., the up-down direction of FIG. 10B) at the middle of the reflector 10 in the front-rear direction. Note that in this example, the reflector 10 is formed of a solid rod-shaped body.

In this example, the center of gravity G is also located inside of the imaginary triangle joining the first, second and third support points S1, S2 and S3. Moreover, in the reflector 10 of this embodiment, the center of gravity G matches the shear center of a cross section of the reflector 10 at the center in the long side direction. Therefore, the shear center is also located inside of the imaginary triangle V3.

According to this example, in addition to the above-described effects, the reflector 10 itself is formed so as to be stably supportable. Thus, the reflector 10 can be more stably supported and influences of a vibration can be suppressed furthermore. Moreover, the center of gravity G and the shear center match each other, so that a vibration and a twist of the reflector 10 can be effectively suppressed.

### Embodiment 3

An image formation apparatus according to this embodiment includes the optical scanner 1. Next, embodiments of an image formation apparatus in which the optical scanner 1 is provided. The image formation apparatus including the optical scanner 1 can be used for various types of image formation apparatuses such as a laser beam printer, a laser facsimile machine and a digital copy machine. As the optical scanner 1, the reflector 10 according to any one of the above-described embodiments and the reflector 10 according to any one of the above-described modified examples can be used.

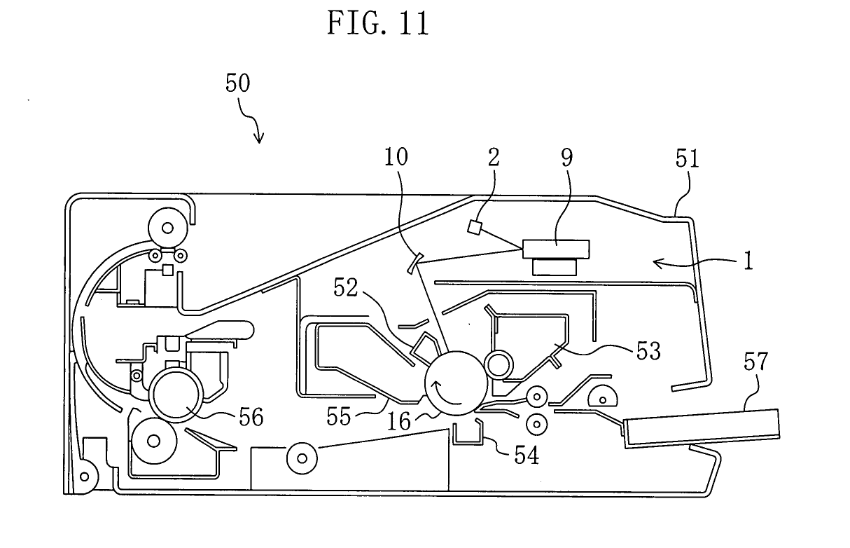

As shown in FIG. 11, the optical scanner 1 (illustration of the case 15 and other elements is omitted) including the light source unit 2, the polygon mirror 9 and the reflector 10 is stored in a casing 51 an image formation apparatus 50. Moreover, in the casing 51, a photosensitive drum 16, a primary charger 52 for attaching electrostatic ions to a rim surface of the photosensitive drum 16 to charge, a developer 53 for attaching charged toner to a printing section, a transfer charger 54 for transferring attached toner to a print paper, a cleaner 55 for removing remaining toner, a printer fuser 56 for fusing transferred toner into the print paper, and a paper feed cassette 57 are provided.

In the image formation apparatus 50 of this embodiment, the above-described optical scanner 1 is used. Thus, reduction in the size of and costs for the apparatus and improvement of performance of the apparatus can be achieved.

Note that in the optical scanner 1, the reflector 10 is supported by the protrusions 31, 32 and 33 formed in the case 15. However, the protrusions 31, 32 and 33 do not have to be united as one but each of them may be formed of a separate member from the case 15. Moreover, the protrusions 31, 32 and 33 can be provided in the reflector 10.

In each of the embodiments of FIGS. 4 and 8, the third support point S3 does not have to be located at the middle of the reflector 10 in the long side direction but may be located at a point shifted from the middle thereof. That is, the third support point S3 can be located substantially in the vicinity of the center potion.

The pressure springs 41, 42 and 43 are provided in points corresponding to the support points S1, S2 and S3, respectively, but may be provided at different points. Moreover, the number of pressure springs does not have to match the number of supporting points. Furthermore, the pressure springs 41, 42 and 43 are useful for firmly supporting the reflector 10 but are not always necessary.

A material for the reflector 10 is not limited to a synthetic resin but some other material can be used. If the second image formation optical system is not formed of only the reflector 10, the reflection plane 20 of the reflector 10 does not have to be a free-form surface.

As has been described, the present invention is useful for an image formation apparatus such as a laser beam printer, a laser facsimile machine and digital copy machine, and an optical scanner used in the image formation apparatus.

1. A method for supporting, in an optical scanner including a reflector for reflecting a ray bundle to be scanned, the reflector,
wherein the reflector includes a reflection plane formed of a curved plane having a long side extending in the scanning direction in which a ray bundle is scanned and having a positive power at least in the scanning direction, and
wherein the reflector is supported at a first support point located in the vicinity of one end of the reflector in the long side direction, a second support point located in the vicinity of the other end of the reflector in the long side direction, and a third support point located in the vicinity of a center of the reflector in the long side direction so as to be more toward a concave side of the reflector plane than an imaginary straight line joining the first support point and the second support point.

2. The method of claim 1, wherein a distance between the third support point and the imaginary straight line is larger than a sag of the reflection plane in the scanning direction.

3. The method of claim 1, wherein first, second and third corresponding points located in parts of an opposite side of the reflector to a side in which the first, second and third support points are located and approximately corresponding to the first, second and third support points, respectively, are pressed toward the first, second and third support points, respectively.

4. The method of claim 3, wherein the reflector includes a thin-plate-shaped reflector body of which one plane serves as a reflection plane and a rib extending from a back side of the reflection plane of the reflector body in the back side direction and having a long side extending in the scanning direction, and
wherein the third corresponding point is located on the rib.

5. The method of claim 1, wherein the reflector includes, with the third support point as a boundary, a first portion including the first support point and a second portion including the second support point,
wherein the center of gravity of the first portion is located on an imaginary straight line joining between the first support point and the third support point, and
wherein the center of gravity of the second portion is located on an imaginary straight line joining the second support point and the third support point.

6. The method of claim 1, wherein the reflector includes, with the third support point as a boundary, a first portion including the first support point and a second portion including the second support point,
wherein a shear center of a cross section of the reflector in a center portion of the first portion in the long side direction is located on the imaginary straight line joining the first support point and the third support point, and
wherein a shear center of a cross section of the reflector in a center portion of the second portion in the long side direction is located on the imaginary straight line joining the second support point and the third support point.

7. The method of claim 6, wherein a center of gravity of the first portion approximately matches the shear center of the cross section of the reflector in the center portion of the first portion in the long side direction, and
wherein a center of gravity of the second portion approximately matches the shear center of the cross section of the reflector in the center portion of the second portion in the long side direction.

8. The method of claim 1, wherein a depth of the center portion of the reflector is larger than a depth of each of end portions of the reflector.

9. The method of claim 1, wherein a second moment of area in the center portion of the reflector is larger than a second moment of area in each of the end potions of the reflector.

10. The method of claim 1, wherein an area of a cross section of the reflector in the vicinity of each of the support points is larger than an area of a cross section of the reflector in a portion located between one of the support points and another.

11. An optical scanner comprising:
a light source for outputting a ray bundle;
an optical deflector for scanning the ray bundle from the light source;
a first image formation optical system, arranged between the light source and the optical deflector, for leading the ray bundle from the light source to a deflecting plane of the optical deflector and for forming a line image on the deflecting plane; and
a second image formation optical system, arranged between the optical deflector and a scanning plane to be scanned, for leading the ray bundle from the optical deflector to the scanning plane and forming an image of a uniform spot on the scanning plane at a uniform velocity,
wherein the second image formation optical system includes a reflector having a reflection plane formed of a curved plane which has a long side extending in the scanning direction in which the ray bundle is scanned and a positive power at least in the scanning direction, and
wherein the optical scanner further includes a support member for supporting the reflector at a first support point located in the vicinity of one end of the reflector in the long side direction, a second support point located in the vicinity of the other end of the reflector in the long side direction, and a third support point located in the vicinity of a center of the reflector in the long side direction so as to be more toward a concave side of the reflector plane than an imaginary straight line joining the first support point and the second support point.

12. The optical scanner of claim 11, wherein a distance between the third support point and the imaginary straight line is larger than a sag of the reflection plane in the scanning direction.

13. The optical scanner of claim 11, further comprising:
a pressure member for pressing first, second and third corresponding points located in parts of an opposite side of the reflector to a side in which the first, second and third support points are located and approximately corresponding to the first, second and third support points, respectively, toward the first, second and third support points, respectively.

14. The optical scanner of claim 13, wherein the reflector includes a thin-plate-shaped reflector body of which one plane serves as a reflection plane and a rib extending from a back side of the reflection plane of the reflector body in the back side direction and having a long side extending in the scanning direction, and
wherein the third corresponding point is located on the rib.

15. The optical scanner of claim 11, wherein the reflector includes, with the third support point as a boundary, a first portion including the first support point and a second portion including the second support point,
wherein the center of gravity of the first portion is located on an imaginary straight line joining between the first support point and the third support point, and
wherein the center of gravity of the second portion is located on an imaginary straight line joining the second support point and the third support point.

16. The optical scanner of claim 11, wherein the reflector includes, with the third support point as a boundary, a first portion including the first support point and a second portion including the second support point,
wherein a shear center of a cross section of the reflector in a center portion of the first portion in the long side direction is located on the imaginary straight line joining the first support point and the third support point, and
wherein a shear center of a cross section of the reflector in a center portion of the second portion in the long side direction is located on the imaginary straight line joining the second support point and the third support point.

17. The optical scanner of claim 16, wherein a center of gravity of the first portion approximately matches the shear center of the cross section of the reflector in the center portion of the first portion in the long side direction, and
wherein a center of gravity of the second portion approximately matches the shear center of the cross section of the reflector in the center portion of the second portion in the long side direction.

18. The optical scanner of claim 11, wherein a depth of the center portion of the reflector is larger than a depth of each of end portions of the reflector.

19. The optical scanner of claim 11, wherein a second moment of area in the center portion of the reflector is larger than a second moment of area in each of the end potions of the reflector.

20. The optical scanner of claim 11, wherein an area of a cross section of the reflector in the vicinity of each of the support points is larger than an area of a cross section of the reflector in a portion located between one of the support points and another.

21. The optical scanner of claim 11, wherein the reflector includes a synthetic resin member having a curved plane and a mirror surface film formed on the curved plane of the synthetic resin member.

22. The optical scanner of claim 11, wherein the second formation optical system is formed of only the reflector.

23. An image formation apparatus comprising:
an optical scanner;
an approximately cylindrical photosensitive body having a rim surface to serve as a scanning plane to be scanned and extending in the scanning direction in which a ray bundle is scanned in the optical scanner;
driving mechanism for rotating the photosensitive body;
a developer for supplying toner to the photosensitive body; and
transferer for transferring a toner image formed on the photosensitive body to a recording medium,
wherein the optical scanner includes
a light source for outputting a ray bundle,
an optical deflector for scanning a ray bundle from the light source,
a first image formation optical system, arranged between the light source and the optical deflector, for leading the ray bundle from the light source to a deflecting plane of the optical deflector and for forming a line image on the deflecting plane, and
a second image formation optical system, arranged between the optical deflector and a scanning plane to be scanned, for leading the ray bundle from the optical deflector to the scanning plane and forming an image of a uniform spot on the scanning plane at a uniform velocity,
wherein the second image formation optical system includes a reflector having a reflection plane formed of a curved plane which has a long side extending in the scanning direction in which the ray bundle is scanned and a positive power at least in the scanning direction, and
wherein the optical scanner further includes a support member for supporting the reflector at a first support point located in the vicinity of one end of the reflector in the long side direction, a second support point located in the vicinity of the other end of the reflector in the long side direction, and a third support point located in the vicinity of a center of the reflector in the long side direction so as to be more toward a concave side of the reflector plane than an imaginary straight line joining the first support point and the second support point.

24. A method for supporting, in an optical scanner including a reflector for reflecting a ray bundle to be scanned, the reflector,
wherein the reflector includes a reflection plane formed of a curved plane having a long side extending in the scanning direction in which a ray bundle is scanned and having a positive power at least in the scanning direction, and
wherein the reflector is supported at first, second and third support points arranged so as to surround a center of gravity of the reflector when viewed from the top.

25. A method for supporting, in an optical scanner including a reflector for reflecting a ray bundle to be scanned, the reflector,
wherein the reflector includes a reflection plane formed of a curved plane having a long side extending in the scanning direction in which a ray bundle is scanned and having a positive power at least in the scanning direction, and
wherein the reflector is supported at first, second and third support points arranged so as to surround a shear center of a cross section of the reflector in a center portion of the reflector when viewed from the top.

26. The method of claim 24, wherein the first and second support points are located in the vicinity of one end of the reflector in the long side direction, and
wherein the third support point is located in the vicinity of the other end of the reflector in the long side direction.

27. The method of claim 25, wherein the first and second support points are located in the vicinity of one end of the reflector in the long side direction, and
wherein the third support point is located in the vicinity of the other end of the reflector in the long side direction.

28. The method of claim 24, wherein the first support point is located in the vicinity of one end portion of the reflector in the long side direction,
wherein the second support point is located in the vicinity of the other end of the reflector in the long side direction, and
wherein the third support point is located in the vicinity of a center portion of the reflector in the long side direction.

29. The method of claim 25, wherein the first support point is located in the vicinity of one end portion of the reflector in the long side direction,
wherein the second support point is located in the vicinity of the other end of the reflector in the long side direction, and
wherein the third support point is located in the vicinity of a center portion of the reflector in the long side direction.

30. The method of claim 28, wherein the third support point is located in the vicinity of a center of the reflector in the long side direction so as to be more toward a concave side of the reflection plane of the reflector than an imaginary straight line joining the first support point and the second support point.

31. The method of claim 29, wherein the third support point is located in the vicinity of a center of the reflector in the long side direction so as to be more toward a concave side of the reflection plane of the reflector than an imaginary straight line joining the first support point and the second support point.

32. The method of claim 24, wherein the center of gravity of the reflector matches a shear center of a cross section of the reflector in a center portion of the reflector in the long side direction.

33. The method of claim 25, wherein the center of gravity of the reflector matches a shear center of a cross section of the reflector in a center portion of the reflector in the long side direction.

34. The method of claim 24, wherein the reflector is formed so that a front portion of the reflector in which the reflection plane is formed and a rear portion of the reflector located in a back side of the reflection plane are symmetrical to each other with respect to a plane including the middle of the reflector in the front-rear direction and having the long side direction of the reflector and the support direction of each of the support points.

35. The method of claim 25, wherein the reflector is formed so that a front portion of the reflector in which the reflection plane is formed and a rear portion of the reflector located in a back side of the reflection plane are symmetrical to each other with respect to a plane including the middle of the reflector in the front-rear direction and having the long side direction of the reflector and the support direction of each of the support points.

36. An optical scanner comprising:
a light source for outputting a ray bundle;
an optical deflector for scanning the ray bundle from the light source;
a first image formation optical system, arranged between the light source and the optical deflector, for leading the ray bundle from the light source to a deflecting plane of the optical deflector and for forming a line image on the deflecting plane; and
a second image formation optical system, arranged between the optical deflector and a scanning plane to be scanned, for leading the ray bundle from the optical deflector to the scanning plane and forming an image of a uniform spot on the scanning plane at a uniform velocity,
wherein the second image formation optical system includes a reflector having a reflection plane formed of a curved plane which has a long side extending in the scanning direction in which the ray bundle is scanned and a positive power at least in the scanning direction,
wherein the optical scanner further includes first, second and third support members for supporting the reflector at first, second and third support points, respectively, and
wherein a center of gravity of the reflector is located inside of an imaginary triangle joining the first, second and third support points when viewed from the top.

37. An optical scanner comprising:
a light source for outputting a ray bundle;
an optical deflector for scanning the ray bundle from the light source;
a first image formation optical system, arranged between the light source and the optical deflector, for leading the ray bundle from the light source to a deflecting plane of the optical deflector and for forming a line image on the deflecting plane; and
a second image formation optical system, arranged between the optical deflector and a scanning plane to be scanned, for leading the ray bundle from the optical deflector to the scanning plane and forming an image of a uniform spot on the scanning plane at a uniform velocity,
wherein the second image formation optical system includes a reflector having a reflection plane formed of a curved plane which has a long side extending in the scanning direction in which the ray bundle is scanned and a positive power at least in the scanning direction,
wherein the second image formation optical system further includes first, second and third support members for supporting the reflector at first, second and third support points, respectively, and
wherein a shear center of a cross section of the reflector in a center portion of the reflector in the long side direction is located inside of an imaginary triangle joining the first, second and third support points when viewed from the top.

38. The optical scanner of claim 36, wherein the first and second support points are located in the vicinity of one end of the reflector in the long side direction, and
wherein the third support point is located in the vicinity of the other end of the reflector in the long side direction.

39. The optical scanner of claim 37, wherein the first and second support points are located in the vicinity of one end of the reflector in the long side direction, and
wherein the third support point is located in the vicinity of the other end of the reflector in the long side direction.

40. The optical scanner of claim 36, wherein the first support point is located in the vicinity of one end of the reflector in the long side direction,
wherein the second support point is located in the vicinity of the other side of the reflector in the long side direction, and
wherein the third support point is located in the vicinity of a center portion of the reflector in the long side direction.

41. The optical scanner of claim 37, wherein the first support point is located in the vicinity of one end of the reflector in the long side direction,
wherein the second support point is located in the vicinity of the other side of the reflector in the long side direction, and
wherein the third support point is located in the vicinity of a center portion of the reflector in the long side direction.

42. The optical scanner of claim 40, wherein the third support point is located so as to be more toward a concave side of the reflection plane of the reflector than an imaginary straight line joining the first support point and the second support point.

43. The optical scanner of claim 41, wherein the third support point is located so as to be more toward a concave of the reflection plane of the reflector than an imaginary straight line joining the first support point and the second support point.

44. The optical scanner of claim 36, wherein the center of gravity of the reflector matches a shear center of a cross section of the reflector in a center portion of the reflector in the long side direction.

45. The optical scanner of claim 37, wherein the center of gravity of the reflector matches a shear center of a cross section of the reflector in a center portion of the reflector in the long side direction.

46. The optical scanner of claim 36, wherein the reflector is formed so that a front portion of the reflector in which the reflection plane is formed and a rear portion of the reflector which is located in a back side of the reflection plane are symmetrical to each other with respect to a plane including the middle of the reflector in the front-rear direction and having the long side direction of the reflector and the support direction of each of the support points.

47. The optical scanner of claim 37, wherein the reflector is formed so that a front portion of the reflector in which the reflection plane is formed and a rear portion of the reflector which is located in a back side of the reflection plane are symmetrical to each other with respect to a plane including the middle of the reflector in the front-rear direction and having the long side direction of the reflector and the support direction of each of the support points.

48. The optical scanner of claim 36, wherein the reflector includes a synthetic resin member having a curved plane and a mirror surface film formed on the curved plane of the synthetic resin member.

49. The optical scanner of claim 37, wherein the reflector includes a synthetic resin member having a curved plane and a mirror surface film formed on the curved plane of the synthetic resin member.

50. The optical scanner of claim 36, wherein the second formation optical system is formed of only the reflector.

51. The optical scanner of claim 37, wherein the second formation optical system is formed of only the reflector.

52. An image formation apparatus comprising:
an optical scanner;
an approximately cylindrical photosensitive body having a rim surface to serve as a scanning plane and extending in the scanning direction in which a ray bundle is scanned in the optical scanner;
driving mechanism for rotating the photosensitive body;
a developer for supplying toner to the photosensitive body; and
transferer for transferring a toner image formed on the photosensitive body to a recording medium,
wherein the optical scanner includes
a light source for outputting a ray bundle,
an optical deflector for scanning a ray bundle from the light source,
a first image formation optical system, arranged between the light source and the optical deflector, for leading the ray bundle from the light source to a deflecting plane of the optical deflector and for forming a line image on the deflecting plane, and
a second image formation optical system, arranged between the optical deflector and a scanning plane to be scanned, for leading the ray bundle from the optical deflector to the scanning plane and forming an image of a uniform spot on the scanning plane at a uniform velocity,
wherein the second image formation optical system includes a reflector having a reflection plane formed of a curved plane which has a long side extending in the scanning direction in which the ray bundle is scanned and a positive power at least in the scanning direction, and
wherein the optical scanner further includes first, second and third support members for supporting the reflector at first, second and third support points, respectively, and
wherein a center of gravity of the reflector is located inside of an imaginary triangle joining the first, second and third support points when viewed from the top.

53. An image formation apparatus comprising:
an optical scanner;
an approximately cylindrical photosensitive body having a rim surface to serve as a scanning plane and extending in the scanning direction in which a ray bundle is scanned in the optical scanner;
driving mechanism for rotating the photosensitive body;
a developer for supplying toner to the photosensitive body; and
transferer for transferring a toner image formed on the photosensitive body to a recording medium,
wherein the optical scanner includes a light source for outputting a ray bundle,
an optical deflector for scanning a ray bundle from the light source,
a first image formation optical system, arranged between the light source and the optical deflector, for leading the ray bundle from the light source to a deflecting plane of the optical deflector and for forming a line image on the deflecting plane, and
a second image formation optical system, arranged between the optical deflector and a scanning plane to be scanned, for leading the ray bundle from the optical deflector to the scanning plane and forming an image of a uniform spot on the scanning plane at a uniform velocity,
wherein the second image formation optical system includes a reflector having a reflection plane formed of a curved plane which has a long side extending in the scanning direction in which the ray bundle is scanned and a positive power at least in the scanning direction, and
wherein the optical scanner further includes first, second and third support members for supporting the reflector at first, second and third support points, respectively, and
wherein a shear center of a cross section of the reflector in a center portion of the reflector in the long side direction is located inside of an imaginary triangle joining the first, second and third support points when viewed from the top.
